(19) United States
(12) Patent Application Publication
(10) Pub. No.: US 2004/0052426 A1
(43) Pub. Date: Mar. 18, 2004

(54) Non-iterative method and system for phase retrieval

(75) Inventor: Barbara T. Landesman, Albuquerque, NM (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Lockheed Martin Corporation, Bethesda, MD

(21) Appl. No.: 10/353,758

(22) Filed: Jan. 28, 2003

Related U.S. Application Data
(60) Provisional application No. 60/409,977, filed on Sep. 12, 2002.

(51) Int. Cl. G06K 9/40

(52) U.S. Cl. 382/255

(57) ABSTRACT

Non-iterative techniques for phase retrieval for estimating errors of an optical system. A method for processing information for an optical system may include capturing a focused image of an object at a focal point (110), capturing a plurality of unfocused images of the object at a plurality of defocus points respectively (110), processing at least information associated with the focused image and the plurality of unfocused images (120 and 130), and determining a wavefront error without an iterative process (140). In addition, a non-iterative system (400) capable of processing image information is also provided.

### CROSS-REFERENCES TO RELATED APPLICATIONS

This application claims priority to U.S. Provisional No. 60/409,977 filed Sep. 12, 2002, which is incorporated by reference herein.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates generally to imaging techniques. More particularly, the invention provides a method and system for estimating errors in an optical system using at least a non-iterative technique of phase retrieval. Merely by way of example, the invention has been applied to telescope systems, but it would be recognized that the invention has a much broader range of applicability.

Optical system has been widely used for detecting images of various targets. Such optical system introduces discrepancies to the imaging information. The discrepancies including phase errors result from various sources, such as aberrations between input and output of optical system and discrepancies associated with individual segments of optical system including primary mirrors. These error sources are often difficult to eliminate; so their adverse effects on optical imaging need to be estimated and corrected. Various techniques for error estimation have been employed, including phase diversity and phase retrieval. Phase diversity techniques are applicable to images of extended targets, each of which may contain infinite number of points. In contrast, phase retrieval techniques, a subclass of phase diversity techniques, are applicable to images of point targets, such as images of celestial stars.

Phase retrieval techniques generally use only intensity measurements of images in one or more planes near the focal plane. Error calculations from such intensity measurements utilize an iterative algorithm in order to estimate phase error in pupil plane. The algorithm includes iterative Fourier transformations between images and pupil planes using the measured intensities and constraints in Fourier domains. The iterative nature of the algorithm and its progeny makes the error estimation computationally intensive and occasionally unstable.

The iterative algorithms of phase retrieval techniques include at least the Gerchberg-Saxton method, also called the error reduction algorithm, the method of steepest descent, also called optimum gradient method, the conjugate gradient method, the Newton-Raphson or damped least squares algorithm, and the input-output algorithm. These algorithms generally use different parameters, involve different calculation steps, and have different convergence rates, but they generally use an iterative process that repeats until an error function reaches a global minimum. In many cases, the global minimum can not be easily reached or can only be falsely reached because the minimum reached is in fact a local minimum.

In addition to problems associated with convergence difficulty and computational intensity as discussed above, phase retrieval techniques cannot retrieve certain information related to imaging errors. Phase retrieval techniques use iterative algorithms to solve for a real-value function, W(ξ,η). W(ξ,η) is the argument of the exponential integrand of a double integral that is itself squared. The double integral introduces an inherent nonlinearity into the retrieval process and the squaring produces a strong smoothing effect. The smoothing effect makes it difficult to retrieve high-frequency component of W(ξ,η). Therefore, only low-frequency component of W(ξ,η) may usually be estimated. This limitation makes it inefficient to commit a large amount of computational capacity to phase retrievals based on iterative algorithms. Hence, it is desirable to simplify phase retrieval techniques.

### BRIEF SUMMARY OF THE INVENTION

The present invention relates generally to imaging techniques. More particularly, the invention provides a method and system for estimating errors in an optical system using at least a non-iterative technique of phase retrieval. Merely by way of example, the invention has been applied to telescope systems, but it would be recognized that the invention has a much broader range of applicability.

According to a specific embodiment of the present invention, non-iterative techniques for phase retrieval to correct errors of an optical system are provided. Merely by way of example, a method for processing information for an optical system includes capturing a first focused image of a first object at a first focal point and capturing a plurality of unfocused images of the first object at a plurality of defocus points having a plurality of distances from the first focal point respectively. In addition, the method includes processing at least information associated with the first focused image and information associated with the plurality of unfocused images, and determining a wavefront error using the processing based upon at least the information associated with the first focused image and the information associated with the plurality of unfocused images. The processing is free from an iterative process.

In another embodiment, a system for processing image information includes an optical system and a control system that comprises a computer-readable medium. The computer-readable medium includes one or more instructions for capturing a first focused image of a first object at a first focal point and one or more instructions for capturing a plurality of unfocused images of the first object at a plurality of defocus points having a plurality of distances from the first focal point respectively. In addition, the computer-readable medium includes one or more instructions for processing at least information associated with the first focused image and information associated with the plurality of unfocused images, and one or more instructions for determining a wavefront error using the processing based upon at least the information associated with the first focused image and the information associated with the plurality of unfocused images. The processing is free from an iterative process.

Many benefits are achieved by way of the present invention over conventional techniques. For example, the present invention improves convergence capabilities of phase retrieval techniques and mitigates problems of over-shooting and under-shooting in estimating errors. In addition, the present invention reduces computation intensity of phase retrieval techniques and can be implemented on various computer platforms such as servers and personal computers.

Depending upon embodiment, one or more of these benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 illustrates a simplified block diagram for a non-iterative method for phase retrieval according to an embodiment of the present invention.

FIG. 2 illustrates a simplified process for capturing focused and unfocused images by optical system according to an embodiment of the present invention.

FIG. 3 illustrates a simplified process for capturing focused and unfocused images by optical system according to another embodiment of the present invention.

FIG. 4 illustrates a simplified block diagram for a non-iterative system for phase retrieval according to an embodiment of the present invention.

### DETAILED DESCRIPTION OF THE INVENTION

The present invention relates generally to imaging techniques. More particularly, the invention provides a method and system for estimating errors in an optical system using at least a non-iterative technique of phase retrieval. Merely by way of example, the invention has been applied to telescope systems, but it would be recognized that the invention has a much broader range of applicability.

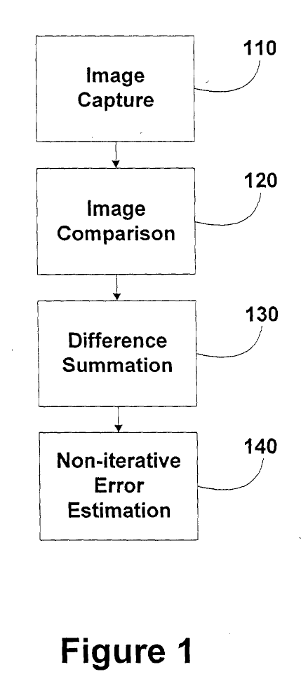

FIG. 1 is a simplified block diagram for a non-iterative method for phase retrieval according to an embodiment of the present invention. This diagram is merely an example, which should not unduly limit the scope of the claims. One of ordinary skill in the art would recognize many variations, alternatives, and modifications. The method includes image capturing 110, image comparison 120, difference summation 130, non-iterative error estimation 140, and possibly others, depending upon the embodiment. Although the above has been shown using a selected sequence of processes, there can be many alternatives, modifications, and variations. For example, some of the processes may be expanded and/or combined. Image comparison 120 and difference summation 130 may be combined. Other processes may be inserted to those noted above. Depending upon the embodiment, the specific sequence of processes may be interchanged with others replaced. Further details of these processes are found throughout the present specification and more particularly below.

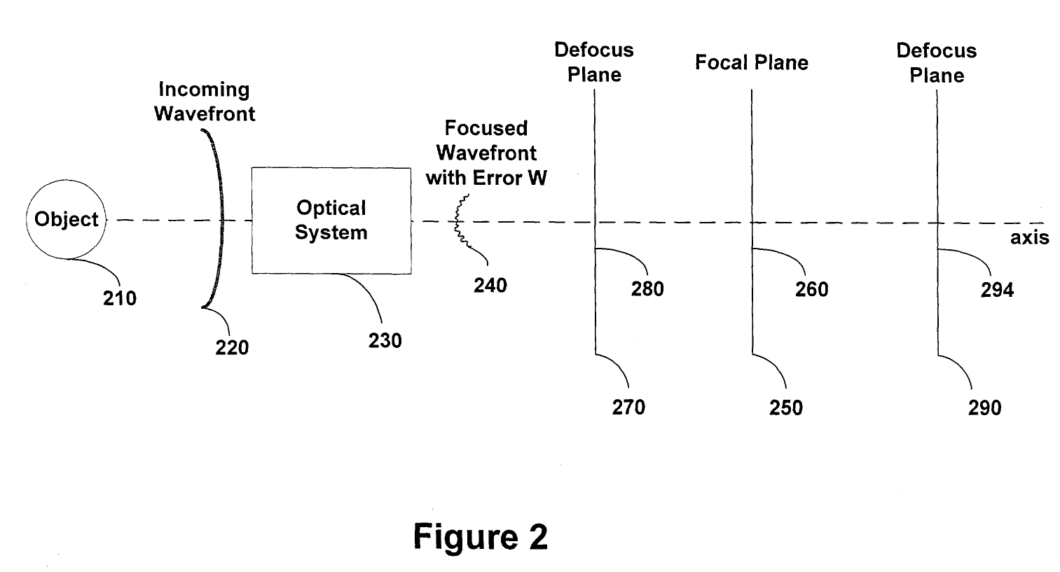

FIG. 2 illustrates a simplified process for capturing focused and unfocused images by optical system according to an embodiment of the present invention. This diagram is merely an example, which should not unduly limit the scope of the claims. One of ordinary skill in the art would recognize many variations, alternatives, and modifications. As shown in FIG. 2, at image capture process 110, an optical system captures image of an object in a focal plane and defocus planes. More specifically, object 210 emits or reflects electrical magnetic signals to form incoming wavefront 220. Object 210 may be a celestial star or other imaging target. Incoming wavefront 220 may be a spherical wavefront, a plane wavefront, or other. Incoming wavefront 220 propagates from object 210 to optical system 230. Optical system 230 may be a telescope, a microscope, other optical system using a phase diversity technique, or other imaging system. Optical system 230 converts incoming wavefront 220 to focused wavefront 240. Focus wavefront 240 contains wavefront error W that is induced by optical system 230, such as aberrations between input and output of optical system 230, and errors associated with segments of optical system 230 including primary mirrors. Focus wavefront 240 converges substantially on a focal plane 250. On focal plane 250, focused image 260 of object 210 is captured. In addition, on either side of focal plane 250, an unfocused image of object 210 on a defocus plane is also captured. For example, on defocus plane 270, unfocused image 280 is obtained. Similarly, on defocus plane 290, unfocused image 294 is obtained.

Focused image 260 of object 210 is usually degraded by wavefront error W of focused wavefront 240. In addition, unfocused image 280 or 294 is usually degraded by not only wavefront error W but also wavefront distortion aΔw. The distortion aΔW results from out-of-focus nature of the defocus plane, as shown below in Equation 1.

aΔW(x,y)=aλ(x²+y²) (Equation 1)

Where aλ is proportional to the distance between defocus plane and focal plane, and λ is the wavelength of focused wavefront. Therefore, a is the amount of waves of defocus plane. For example, as shown in FIG. 2, the distance between defocus plane 270 and focal plane 250 is proportional to aλ, and the distortion for defocus plane 270 is −aΔW. In addition, the wavefront distortion aΔW equals zero for focal plane 250 when aλ for focal plane is also zero.

Focused image captured on focal plane and unfocused image captured on defocus plane may be described by Equations 2 and 3 respectively as shown below.

image_{focus}∝|F{ [symbol] ₀(x,y)×e^{ikW}}|² (Equation 2)

image_{defocus}∝|F{ [symbol] ₀(x,y)×e^{ik(W+aΔW)}}|² (Equation 3)

Where in Equation 2, image_{focus} represents the image captured on focal plane, F denotes Fourier transform, [symbol] (x,y) describes unaberrated pupil, and k is wavenumber. In Equation 3, same symbols have same definitions as in Equation 2. image_{defocus} represents the image captured on defocus plane. For example, as shown in FIG. 2, focused image 260 is image_{focus}; while unfocused image 280 or 294 is image_{defocus}.

As described in Equation 2, image_{focus} captured on focal plane contains wavefront error W. In order to improve image quality, wavefront error W needs to be estimated and corrected. To solve for wavefront error W, we expand the wavefront error exponentials e^{ikW} and e^{ik(W+aΔW)} in Equations 2 and 3 into Taylor series respectively as follows:

$$\begin{matrix}{ⅇ}^{ikW ( x , y )} = {\sum }_{n = 0}^{∞} \frac{{( - 1 )}^{n} {( k W )}^{2 n}}{( 2 n ) !} + i {\sum }_{m = 0}^{∞} \frac{{( - 1 )}^{m} {( k W )}^{2 m + 1}}{( 2 m + 1 ) !} & ( Equation 2 A ) \\ {ⅇ}^{ik ( W + a Δ W )} = {\sum }_{n = 0}^{∞} \frac{{( - 1 )}^{n} {{k}^{2 n} ( W + a Δ W )}^{2 n}}{( 2 n ) !} + i {\sum }_{m = 0}^{∞} \frac{{( - 1 )}^{m} {{k}^{2 m + 1} ( W + a Δ W )}^{2 m + 1}}{( 2 m + 1 ) !} & ( Equation 3 A )\end{matrix}$$

Consequently, image_{focus} and image_{defocus} may be described with the following equation:

$${image}_{captured} ∝ \vert F \{ {ⅇ}^{ik ( W + a Δ W )} {℘}_{0} ( x , y ) \} {\vert}^{2} = \\ \vert {\sum }_{n = 0}^{∞} \frac{{( - 1 )}^{n} {k}^{2 n}}{( 2 n ) !} {\sum }_{p = 0}^{2 n} \frac{( 2 n ) !}{p ! ( 2 n - p ) !} F \{ {{W}^{p} ( a Δ W )}^{2 n - p} {℘}_{0} ( x , y ) \} {\vert}^{2} + \\ \vert {\sum }_{m = 0}^{∞} \frac{{( - 1 )}^{m} {k}^{2 m + 1}}{( 2 m + 1 ) !} {\sum }_{p = 0}^{2 m + 1} \frac{( 2 m + 1 ) !}{p ! ( 2 m + 1 - p ) !} F \{ {{W}^{p} ( a Δ W )}^{2 m + 1 - p} {℘}_{0} ( x , y ) \} {\vert}^{2} \qquad ( Equation 4 )$$

When a equals zero, image_{captured} represents focused image_{focus}; when a does not equal zero, image_{captured} represents unfocused image_{defocus}. Furthermore, Equation 4 may be rewritten as follows:

$$\begin{matrix}{image}_{focus} ∝ \vert F \{ {ⅇ}^{ik W} {℘}_{0} ( x , y ) \} {\vert}^{2} = \\ \vert {\sum }_{n = 0}^{∞} \frac{{( - 1 )}^{n} {k}^{2 n}}{( 2 n ) !} F \{ {W}^{2 n} {℘}_{0} ( x , y ) \} {\vert}^{2} + \\ \vert {\sum }_{m = 0}^{∞} \frac{{( - 1 )}^{m} {k}^{2 m + 1}}{( 2 m + 1 ) !} F \{ {W}^{2 m + 1} {℘}_{0} ( x , y ) \} {\vert}^{2} & ( Equation 5 ) \\ {image}_{defocus} ∝ \vert F \{ {ⅇ}^{ik ( W + a Δ W )} {℘}_{0} ( x , y ) \} {\vert}^{2} = \\ \vert {\sum }_{n = 0}^{∞} \frac{{( - 1 )}^{n} {k}^{2 n}}{( 2 n ) !} {\sum }_{p = 0}^{2 n - 1} \frac{( 2 n ) ! {a}^{2 n - p}}{p ! ( 2 n - p ) !} F \{ {W}^{p} Δ {W}^{2 n - p} {℘}_{0} ( x , y ) \} + \\ {\sum }_{n = 0}^{∞} \frac{{( - 1 )}^{n} {k}^{2 n}}{( 2 n ) !} F \{ {W}^{2 n} {℘}_{0} ( x , y ) \} {\vert}^{2} + \\ \vert {\sum }_{m = 0}^{∞} \frac{{( - 1 )}^{m} {k}^{2 m + 1}}{( 2 m + 1 ) !} {\sum }_{p = 0}^{2 m} \frac{( 2 m + 1 ) ! {a}^{2 m + 1 - p}}{p ! ( 2 m + 1 - p ) !} F \{ {W}^{p} Δ {W}^{2 m + 1 - p} {℘}_{0} ( x , y ) \} + \\ {\sum }_{m = 0}^{∞} \frac{{( - 1 )}^{n} {k}^{2 m + 1}}{( 2 m + 1 ) !} F \{ {W}^{2 m + 1} {℘}_{0} ( x , y ) \} {\vert}^{2} & ( Equation 6 )\end{matrix}$$

Therefore, at image capture step 110, we obtain focused image on focal plane as described in Equation 5, and unfocused image on defocus plane as described in Equation 6. For example, as shown in FIG. 2, Equation 5 represents focused image 260 of object 210; while Equation 6 represents unfocused image 294.

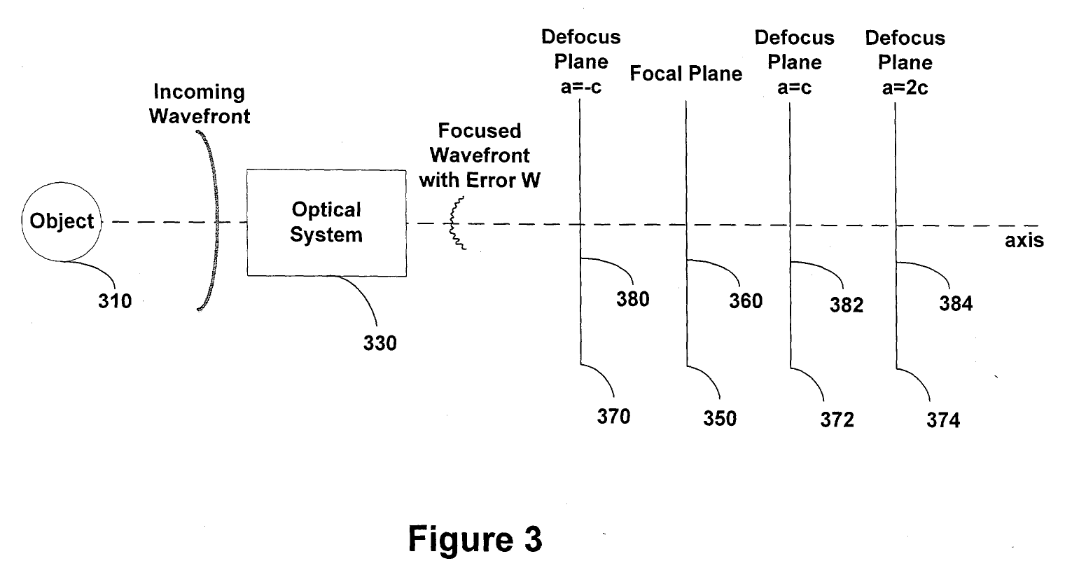

FIG. 3 illustrates a simplified process for capturing focused and unfocused images by optical system according to another embodiment of the present invention. This diagram is merely an example, which should not unduly limit the scope of the claims. One of ordinary skill in the art would recognize many variations, alternatives, and modifications. As shown in FIG. 3, images for object 310 are measured on focal plane 350 and three defocus planes 370, 372, and 374 by optical system 330. Object 310 may be a celestial star or other imaging target. Optical system 330 may be a telescope, a microscope, other optical system using a phase retrieval technique, or other imaging system. Three defocus planes 370, 372, and 374 are located respectively at a equal to −c, c, and 2c, where c is an arbitrary constant. Hence defocus planes 370 and 372 are symmetric with respect to focal plane 350, and defocus plane 374 is twice as distant to focal plane 350 as defocus plane 372 or 374. Focused image captured on focal plane 350 is described by Equation 5, while unfocused images captured on three defocus planes 370, 372, and 374 are described by Equation 6 with a equal to −c, c, and 2c respectively.

At image comparison step 120, focused image and unfocused image are compared as follows:

image_{defocus}−image_{focus}∝|F{e^{ik(W+aΔW)} [symbol] ₀(x,y)}|²−|F{e^{ikW} [symbol] ₀(x,y)}|² (Equation 7)

Applying Equations 5 and 6, Equation 7 becomes

image_{defocus}−image_{focus}∝

$$\vert {\sum }_{n = 1}^{∞} \frac{{( - 1 )}^{n} {k}^{2 n}}{( 2 n ) !} {\sum }_{p = 0}^{2 n - 1} \frac{( 2 n ) ! {a}^{2 n - p}}{p ! ( 2 n - p ) !} F \{ {W}^{p} Δ {W}^{2 n - p} {℘}_{0} ( x , y ) \} {\vert}^{2} + \\ [ {\sum }_{n = 1}^{∞} \frac{{( - 1 )}^{n} {k}^{2 n}}{( 2 n ) !} F \{ {W}^{2 n} {℘}_{0} ( x , y ) \} ] [ {\sum }_{n = 1}^{∞} \frac{{( - 1 )}^{n} {k}^{2 n}}{( 2 n ) !} {\sum }_{p = 0}^{2 n - 1} \frac{( 2 n ) ! {a}^{2 n - p}}{p ! ( 2 n - p ) !} F * \{ {W}^{p} Δ {W}^{2 n - p} {℘}_{0} ( x , y ) \} ] + \\ [ {\sum }_{n = 1}^{∞} \frac{{( - 1 )}^{n} {k}^{2 n}}{( 2 n ) !} F * \{ {W}^{2 n} {℘}_{0} ( x , y ) \} ] [ {\sum }_{n = 1}^{∞} \frac{{( - 1 )}^{n} {k}^{2 n}}{( 2 n ) !} {\sum }_{p = 0}^{2 n - 1} \frac{( 2 n ) ! {a}^{2 n - p}}{p ! ( 2 n - p ) !} F \{ {W}^{p} Δ {W}^{2 n - p} {℘}_{0} ( x , y ) \} ] + \\ {a}^{2} {k}^{2} \vert {\sum }_{m = 0}^{∞} \frac{{( - 1 )}^{m} {k}^{2 m}}{( 2 m + 1 ) !} {\sum }_{p = 0}^{2 m} \frac{( 2 m + 1 ) ! {a}^{2 m - p}}{p ! ( 2 m + 1 - p ) !} F \{ {W}^{p} Δ {W}^{2 m + 1 - p} {℘}_{0} ( x , y ) \} {\vert}^{2} + \\ a {k}^{2} [ {\sum }_{m = 0}^{∞} \frac{{( - 1 )}^{m} {k}^{2 m}}{( 2 m + 1 ) !} F \{ {W}^{2 m + 1} {℘}_{0} ( x , y ) \} ] [ {\sum }_{m = 0}^{∞} \frac{{( - 1 )}^{m} {k}^{2 m}}{( 2 m + 1 ) !} {\sum }_{p = 0}^{2 m} \frac{( 2 m + 1 ) ! {a}^{2 m - p}}{p ! ( 2 m + 1 - p ) !} F * \{ {W}^{p} Δ {W}^{2 m + p} {℘}_{0} ( x , y ) \} ] + \\ a {k}^{2} [ {\sum }_{m = 0}^{∞} \frac{{( - 1 )}^{m} {k}^{2 m}}{( 2 m + 1 ) !} F * \{ {W}^{2 m + 1} {℘}_{0} ( x , y ) \} ] [ {\sum }_{m = 0}^{∞} \frac{{( - 1 )}^{m} {k}^{2 m}}{( 2 m + 1 ) !} {\sum }_{p = 0}^{2 m} \frac{( 2 m + 1 ) ! {a}^{2 m - p}}{p ! ( 2 m + 1 - p ) !} F \{ {W}^{p} Δ {W}^{2 m + 1 - p} {℘}_{0} ( x , y ) \} ]$$

Image comparison as described in Equation 8 may be simplified if wavefront error W is small. When wavefront error W is small, the wavefront error exponentials in Equations 2A and 3A may be simplified as follows:

$$\begin{matrix}{ⅇ}^{ik W ( x , y )} = {\sum }_{n = 0}^{1} \frac{{( - 1 )}^{n} {( k W )}^{2 n}}{( 2 n ) !} + i {\sum }_{m = 0}^{0} \frac{{( - 1 )}^{m} {( k W )}^{2 m + 1}}{( 2 m + 1 ) !} & ( Equation 9 ) \\ {ⅇ}^{ik ( W + a Δ W )} = {\sum }_{n = 0}^{1} \frac{{( - 1 )}^{n} {{k}^{2 n} ( W + a Δ W )}^{2 n}}{( 2 n ) !} + i {\sum }_{m = 0}^{0} \frac{{( - 1 )}^{m} {{k}^{2 m + 1} ( W + a Δ W )}^{2 m + 1}}{( 2 m + 1 ) !} & ( Equation 10 )\end{matrix}$$

Where the maximum value of n is limited to 1 and the maximum value of m is limited to 0. For example, wavefront error W is usually small when a telescope conducts fine acquisition of images. Consequently, Equation 8 becomes

image_{defocus}−image_{defocus}∝

$${( \frac{{k}^{2}}{2 !} )}^{2} [ {a}^{4} \vert F \{ Δ {W}^{2} {℘}_{0} ( x , y ) \} {\vert}^{2} + 4 {a}^{2} \vert F \{ W Δ W {℘}_{0} ( x , y ) \} {\vert}^{2} + \\ 2 {a}^{3} F * \{ Δ {W}^{2} {℘}_{0} ( x , y ) \} F \{ W Δ W {℘}_{0} ( x , y ) \} + 2 {a}^{3} F \{ Δ {W}^{2} {℘}_{0} ( x , y ) \} F * \{ W Δ W {℘}_{0} ( x , y ) \} ] + \\ a {k}^{2} F * \{ Δ W {℘}_{0} ( x , y ) \} F \{ W {℘}_{0} ( x , y ) \} + a {k}^{2} F \{ Δ W {℘}_{0} ( x , y ) \} F * \{ W {℘}_{0} ( x , y ) \} + {a}^{2} {k}^{2} {\vert F \{ Δ W {℘}_{0} ( x , y ) \} \vert}^{2} - \\ {\frac{{k}^{2}}{2} [ - \frac{{k}^{2}}{2 !} F \{ {W}^{2} {℘}_{0} ( x , y ) \} + {P}_{0} ( ξ , η ) ]}^{*} [ {a}^{2} F \{ Δ {W}^{2} {℘}_{0} ( x , y ) \} + 2 a F \{ W Δ W {℘}_{0} ( x , y ) \} ] - \\ {\frac{{k}^{2}}{2} [ - \frac{{k}^{2}}{2 !} F \{ {W}^{2} {℘}_{0} ( x , y ) \} + {P}_{0} ( ξ , η ) ] [ {a}^{2} F \{ Δ {W}^{2} {℘}_{0} ( x , y ) \} + 2 a F \{ W Δ W {℘}_{0} ( x , y ) \} ]}^{*} \qquad ( Equation 11 )$$

Hence at image comparison step 120, an unfocused image is compared with the focused image. For example, as shown in FIG. 2, Equation 11 may describe difference between image 280 or 294 and image 260.

At difference summation step 130, image differences corresponding to different pairs of unfocused image and focused image for the same object are added as follows.

sumdifferences

$$sumdifferences = {\sum }_{i = 0}^{N} {C}_{i} ( {image}_{defocus , i} - {image}_{focus} ) \qquad ( Equation 12 )$$

Where N+1 represents total number of unfocused images captured for an object, and Cᵢ is summation coefficient. image_{defocus,i}−image_{focus} represents image comparison between each pair of unfocused image and focused image for the same object as described in Equation 11. As shown in Equation 11, image_{defocus,i}−image_{focus} depends on a for each respective defocus plane. By choosing proper values of N, a for each defocus plane, and Cᵢ, all terms on the right side of Equation 11 for N+1 unfocused images are canceled, except the following three terms:

$$\begin{matrix}( \frac{{k}^{2}}{2 !} ) {a}^{4} \vert F \{ Δ {W}^{2} {℘}_{0} ( x , y ) \} \vert 2 \\ {( \frac{{k}^{2}}{2 !} )}^{2} 2 {a}^{3} F * \{ Δ {W}^{2} {℘}_{0} ( x , y ) \} F \{ W Δ W {℘}_{0} ( x , y ) \} , and \\ {( \frac{{k}^{2}}{2 !} )}^{2} 2 {a}^{3} F \{ Δ {W}^{2} {℘}_{0} ( x , y ) \} F * \{ W Δ W {℘}_{0} ( x , y ) \}\end{matrix}$$

Hence summation of image differences as shown in Equation 12 can be described as follows:

$$sumdifferences = {\sum }_{i = 0}^{N} {C}_{i} ( {image}_{defocus , i} - {image}_{focus} ) ∝ \\ \begin{matrix}{( \frac{{k}^{2}}{2 !} )}^{2} \vert F \{ Δ {W}^{2} {℘}_{0} ( x , y ) \} {\vert}^{2} {\sum }_{i = 0}^{N} ( {C}_{i} \times {a}_{i}^{4} ) + \\ {( \frac{{k}^{2}}{2 !} )}^{2} 2 F * \{ Δ {W}^{2} {℘}_{0} ( x , y ) \} F \{ W Δ W {℘}_{0} ( x , y ) \} {\sum }_{i = 0}^{N} ( {C}_{i} \times {a}_{i}^{3} ) + \\ {( \frac{{k}^{2}}{2 !} )}^{2} 2 F \{ Δ {W}^{2} {℘}_{0} ( x , y ) \} F * \{ W Δ W {℘}_{0} ( x , y ) \} {\sum }_{i = 0}^{N} ( {C}_{i} \times {a}_{i}^{4} )\end{matrix} \qquad ( Equation 13 )$$

For example, as shown in FIG. 3, unfocused images 380, 382, and 384 of object 310 are captured on three defocus planes 370, 372, and 374. Hence N equals 2. These images are each compared with focused image 360 captured on focal plane 350. The comparisons between each pair of unfocused image and focused image are then added with C₀ equal to b for image 384, C₁ equal to −3b for image 382, and C₂ equal to −b for image 380, where b is an arbitrary constant. According to Equations 11 and 12, all terms on the right side of Equation 11 are canceled, and summation of image differences is described by Equation 13. More specifically, when b equals 1 and C₀, C₁, and C₂ equal respectively to 1, −3, and −1, sumdifferences as described in Equation 13 can be rewritten as follows:

$$sumdifferences = {\sum }_{i = 0}^{2} {C}_{i} ( {image}_{defocus , i} - {image}_{focus} ) ∝ \\ 3 {k}^{4} [ \vert F \{ Δ {W}^{2} {℘}_{0} ( x , y ) \} {\vert}^{2} + F \{ Δ {W}^{2} {℘}_{0} ( x , y ) \} F * \{ W Δ W {℘}_{0} x , y ) \} + \\ F * \{ Δ {W}^{2} {℘}_{0} ( x , y ) \} F \{ W Δ W {℘}_{0} ( x , y ) \} ] \qquad ( Equation 14 )$$

Next, at non-iterative error estimation step 140, wavefront error W is solved analytically from summation of image differences. As described in Equation 14, W is contained in an equations all of whose terms except W are known quantities. For example,

$${\sum }_{i = 0}^{N} {C}_{i} ( {image}_{defocus , i} - {image}_{focus} )$$

can be calculated based on measured unfocused and focused images. Therefore W can be calculated analytically, rather than iteratively, from Equation 14.

For example, as described above and as shown in FIG. 3, C₀, C₁, and C₂ equal to 1, −3, and −1 for images 380, 382, and 384 respectively. Equation 13 for difference summation can be rewritten into Equation 14. Assuming ΔW(x,y) is an even function and [symbol] ₀(x,y) is symmetric, W is solved in the following equation:

$$Re [ F \{ W Δ W {℘}_{0} ( x , y ) \} ] = \frac{{\sum }_{i = 0}^{N} {C}_{i} ( {image}_{defocus , i} - {image}_{focus} ) / {Factor}_{normalization}}{6 {k}^{4} \vert F \{ Δ {W}^{2} {℘}_{0} ( x , y ) \} \vert} - \frac{\vert F \{ Δ {W}^{2} {℘}_{0} ( x , y ) \} \vert}{2}$$

Where Factor_{normalization} is used to normalize measured image data and compensate for various noises such as amplification noises associated with discrepancies between different channels. Equation 15 provides an analytic solution for wavefront error W without relying on any iterative process.

As noted above and further emphasized here, exemplary values of Cᵢ and a for each unfocused image as discussed above do not limit the scope of the present invention. Other combinations of Cᵢ and a for each unfocused image can also simplify image_{defocus,i}−image_{focus} into Equation 13. Further, in the above analyses, we assumed wavefront error W to be small, but the present invention is not limited to any magnitude of wavefront error W. For a larger wavefront error, more terms of Taylor series expansions in Equations 2A and 2B need to be maintained. Hence the maximum value of n may be equal to, or smaller or larger than 1 as adopted in Equation 9, and the maximum value of m may be equal to or larger than 0 as adopted in Equation 10. By properly choosing the total number of unfocused images, location of defocus planes associated with each unfocused image, and summation coefficient Cᵢ for each pair of unfocused image and focused image, we can cancel many terms on the left side of Equation 11 in summation of image differences as defined by Equation 12.

For example, the number of diversity planes used may equal to the number of terms maintained in Taylor series expansions as described in Equations 2A and 2B. For another example, two unfocused planes spaced with equal distance on either side of focal plane may cause all odd higher-order terms in a to vanish and all of the even terms in a to double if summation coefficients for both defocus planes are equal. In contrast, if summation coefficients for these defocus planes have a ratio of −1, all odd higher-order terms in a are doubled and all of the even terms in a are canceled. For yet another example, by properly choosing the total number of unfocused images, a for each defocus plane associated with each unfocused image, and Cᵢ, number of terms left on the left side of Equations may be as small as one.

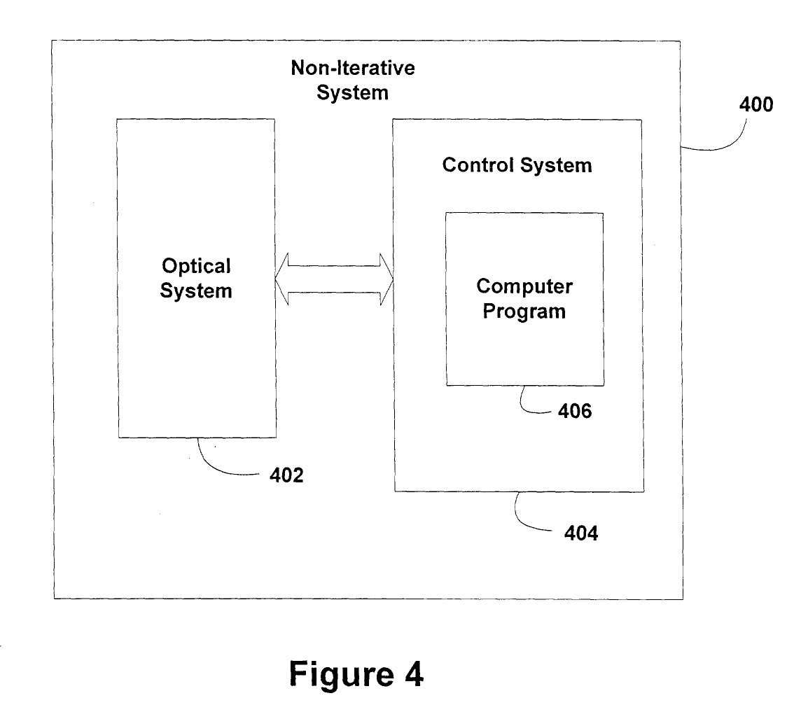

FIG. 4 is a simplified block diagram for a non-iterative system for phase retrieval according to yet another embodiment of the present invention. This diagram is merely an example, which should not unduly limit the scope of the claims. One of ordinary skill in the art would recognize many variations, alternatives, and modifications. As shown in FIG. 4, non-iterative system 400 comprises optical system 402, control system 404, and possibly others, depending upon embodiment. Control system 404 stores computer program 406. Computer program 406 directs, through control system 404, optical system 402 to perform four steps: image capture, image comparison, difference summation, and non-iterative error estimation, substantially as discussed above. For example, optical system 402 may be a telescope, a microscope, other optical system using a phase diversity technique, or other imaging system. For another example, control system 404 may be a computer system or a custom processing chip, and store computer program 406 on local hard disk, floppy diskette, CD-ROM, or remote storage unit over a digital network. Although the above has been shown using selected systems 402 and 404, there can be many alternatives, modifications, and variations. For example, some of the systems may be expanded and/or combined. Other systems may be added in addition to those noted above.

The wavefront error W estimated analytically as discussed above may be used to correct focused images captured. For example, as shown in FIG. 3, focused image 360 may be corrected to compensate for the wavefront error W after the wavefront error W has been estimated analytically. In addition, optical system 330 may capture another focused image of object 310 or another object. The another focused image may also be corrected with the estimated wavefront error W.

The wavefront error W estimated analytically as discussed above may be used to calibrate the optical system. For example, the optical system may be a telescope on a space craft such as a communication satellite. The telescope may capture images of an artificial bright star and then analytically estimate the wavefront error W. If the wavefront error W is larger than the maximum error allowed for the telescope, the telescope would be adjusted in various ways including improving alignment of primary mirrors.

It is understood the examples and embodiments described herein are for illustrative purposes only and that various modifications or changes in light thereof will be suggested to persons skilled in the art and are to be included within the spirit and purview of this application and scope of the appended claims.

What is claimed is:

1. A method for processing information for an optical system, the method comprising:
capturing a first focused image of a first object at a first focal point;
capturing a plurality of unfocused images of the first object at a plurality of defocus points having a plurality of distances from the first focal point respectively;
processing at least information associated with the first focused image and information associated with the plurality of unfocused images; and
determining a wavefront error using the processing based upon at least the information associated with the first focused image and the information associated with the plurality of unfocused images;
whereupon the processing is free from an iterative process.

2. The method of claim 1 wherein the determining a wavefront error further comprising:
determining image difference based upon at least the information associated with the first focused image and the information associated with the plurality of unfocused images; and
estimating the wavefront error using an analytical process, the analytical process being free from any iterative step using the information associated with the first focused image and the information associated with the plurality of unfocused images.

3. The method of claim 2 wherein the determining image difference further comprising:
obtaining a plurality of differences by subtracting the information associated with the first focused image from the information associated with each of the plurality of unfocused images;
obtaining a plurality of truncated Taylor series expansions by keeping only a number of terms for each of a plurality of Taylor series expansions, the plurality of Taylor series expansions obtained by expanding a plurality of wavefront error exponentials for the first focused image and for each of the plurality of unfocused images;
obtaining a plurality of simplified relations between the wavefront error and the information associated with the first focused image and between the wavefront error and the information associated with each of the plurality of unfocused images; and
obtaining a plurality of simplified differences between the information associated with the first focused image and the information associated with each of the plurality of unfocused images, the information associated with the first focused image having one of the simplified relations, the information associated with each of the plurality of unfocused images having one of the simplified relations.

4. The method of claim 3 wherein the determining image difference further comprising:
calculating a plurality of products by multiplying one of a plurality of summation coefficients to each of the plurality of differences; and
obtaining a sum of image differences by adding the plurality of products.

5. The method of claim 4 wherein the estimating the wavefront error using an analytical process further comprising:
determining the number of the plurality of unfocused images, location of each of the plurality of defocus points, and each of the plurality of summation coefficients, in order to obtaining an analytical relation between the wavefront error and the sum of image differences; and
estimating the wavefront error analytically;
whereupon the estimating is free from an iterative process using the information associated with the first focused image and the information associated with the plurality of unfocused images.

6. The method of claim 5 wherein the number of plurality of unfocused images equals the number of terms.

7. The method of claim 6 wherein the number of plurality of unfocused images equals three.

8. The method of claim 7 wherein a first and a second unfocused images of the plurality of unfocused images are captured at a first and a second defocus points of the plurality of defocus points, the first and the second defocus points having a first and a second distances of the plurality of distances from the first focal point, the first and the second defocus points being on opposite sides of the first focal point.

9. The method of claim 8 wherein a third unfocused image of the plurality of unfocused images is captured at a third defocus point of the plurality of defocus points, the third defocus point located at a third distance of the plurality of distances from the first focal point, the third distance being twice as large as the second distance, the second distance equal to the first distance.

10. The method of claim 9 wherein the plurality of summation coefficients equals −b, −3b, and b for the first unfocused image, the second unfocused image, and the third unfocused image respectively, b being a constant.

11. The method of claim 1 wherein the capturing a first focused image comprises:
fine acquisition of the first focused image.

12. The method of claim 11 wherein the capturing a plurality of unfocused images comprises:
fine acquisition of the plurality of unfocused images.

13. The method of claim 1 wherein the optical system is selected from a group consisting of a telescope and a microscope.

14. The method of claim 1 wherein the optical system is an optical system using a phase diversity technique.

15. The method of claim 1 wherein the wavefront error is provided to calibrate the optical system.

16. The method of claim 1 wherein the wavefront error is provided to correct the first focused image.

17. The method of claim 1 wherein the wavefront error is provided to correct a second focused image of the first object captured at a second focal point.

18. The method of claim 1 wherein the wavefront error is provided to correct a second focused image of a second object captured at a second focal point.

19. A system for processing image information, the system comprising:
an optical system;
a control system comprising a computer-readable medium, the computer-readable medium comprising:
one or more instructions for capturing a first focused image of a first object at a first focal point;
one or more instructions for capturing a plurality of unfocused images of the first object at a plurality of defocus points having a plurality of distances from the first focal point respectively;
one or more instructions for processing at least information associated with the first focused image and information associated with the plurality of unfocused images; and
one or more instructions for determining a wavefront error using the processing based upon at least the information associated with the first focused image and the information associated with the plurality of unfocused images;
whereupon the processing is free from an iterative process.

20. The system of claim 19 wherein the determining a wavefront error further comprising:
determining image differences based upon at least the information associated with the first focused image and the information associated with the plurality of unfocused images; and
estimating the wavefront error using an analytical process, the analytical process being free from an iterative step using at least the information associated with the first focused image and the information associated with the plurality of unfocused images.

21. The system of claim 19 wherein the optical system is selected from a group consisting of a telescope and a microscope.

22. The system of claim 19 wherein the optical system is an optical system using a phase diversity technique.

23. The system of claim 19 wherein the control system calibrates the optical system in response to the wavefront error.

24. The system of claim 19 wherein the control system corrects the first focused image in response to the wavefront error.

25. The system of claim 19 wherein the control system corrects a second focused image of the first object captured at a second focal point in response to the wavefront error.

26. The system of claim 19 wherein the control system corrects a second focused image of a second object captured at a second focal point in response to the wavefront error.
